(19) United States
(12) Patent Application Publication
(10) Pub. No.: US 2026/0163086 A1
(43) Pub. Date: Jun. 11, 2026

(54) MASTER CELL FOR PRESSURIZED DATA ACQUISITION AND TRAY FOR ACCOMMODATING THE SAME

(71) Applicants: SHL CO., LTD., Suwon-si (KR); Kitronyx Inc., Seoul (KR)

(72) Inventors: Gi Young KWAK, Suwon-si (KR); Wook CHANG, Seoul (KR)

(21) Appl. No.: 19/414,079

(22) Filed: Dec. 9, 2025

(30) Foreign Application Priority Data
Dec. 10, 2024 (KR) 10-2024-0183121

(51) Int. Cl. H01M 10/46; G01L 17/00; G01L 27/00; H01M 50/211; H02J 7/70

(52) U.S. Cl. CPC H01M 10/46; G01L 17/005; G01L 27/002; H01M 50/211; H02J 7/70

(57) ABSTRACT

A master cell for pressurized data acquisition including a cell body inserted between pressurization panels on behalf of a pressurization target, a pair of measuring electrodes to measure resistance, which protrude from both ends of the cell body, respectively, and are connected to resistors with known resistance values for calibration, an electronic pressure mapping film installed flat on one side surface of the cell body to make surface contact with the pressurization target and output distribution of a pressurizing force by the pressurization panel as an electrical signal, a communication unit to transmit the electrical signal output from the electronic pressure mapping film as a wireless signal, and a battery provided in the cell body to provide power to the electronic pressure mapping film and the communication unit, in which the battery is charged by charging power supplied through charging electrodes provided in the cell body.

### CROSS REFERENCE TO RELATED APPLICATION

This application claims priority from and the benefit of Korean Patent Application

No. 10-2024-0183121, filed on Dec. 10, 2024, which is hereby incorporated by reference for all purposes as if fully set forth herein.

### BACKGROUND

### Field

Embodiments of the invention relate generally to a master cell for pressurized data acquisition and a tray for accommodating the same, and more particularly, to a master cell for pressurized data acquisition and a tray for accommodating the same, which enables the measurement of the flatness, parallelism, pressurizing force, and even resistance of a pressurization panel that pressurizes a pressurization target and enables the accurate and easy acquisition and provision of pressurized data for the pressurization panel.

### Discussion of the Background

Generally, secondary batteries are rechargeable and capable of supporting high capacity, and representative examples include nickel-cadmium, nickel-metal hydride, and lithium-ion batteries. Among these secondary batteries, some can be manufactured in a flexible pouch type, which provides advantages in terms of relatively flexible shape.

Such a cell pouch for a secondary battery is configured such that a battery cell is accommodated therein and a polymer pouch exterior surrounds the battery cell, and to this end, the cell pouch for a secondary battery is composed of an electrode, a pouch, and a battery cell. In addition, when an internal structure of the cell pouch for a secondary battery is damaged or destroyed, resulting in a breakdown in insulation, the battery cell cannot maintain a steady-state voltage, resulting in low voltage, swelling of the battery cell, etc.

Accordingly, the cell pouch for a secondary battery needs to be operated in such a manner that defects can be fundamentally eliminated by inspecting potential defects including insulation-line defects, and as the related art, Korean Patent Registration No. 10-1896218, entitled “Simultaneous inspection device for multiple cell pouches for a secondary battery” has been disclosed. The cell pouch for a secondary battery includes a support member installed for support, a movable member installed to face the support member, a plurality of pressurization panels installed in parallel between the support member and the movable member, coupled so that intervals therebetween can be adjusted by forward and backward movement of the movable member, and in which the cell pouch for a secondary battery is inserted into a gap formed therebetween, a guide member that guides the pressurization panels to move in an interval adjustment direction, an electrode module, which is fixed to the pressurization panel so as to be installed in plural between the pressurization panels to move together with the pressurization panels, and is connected to each electrode portion of the cell pouch for a secondary battery positioned in the gap to apply or receive current, and a pressurization driving unit which pressurizes and depressurizes both side surfaces of the cell pouch for a secondary battery between the pressure panels by moving the movable member forward and rearward, in which the electrode module includes a fixed member fixed to one side surface of the pressurization panel, an electrode actuator fixed to the fixed member and having a movable tip which is disposed in the interval adjustment direction and has an adjustable interval, a fixed piece fixed to each of the movable tips, and electrodes which are installed to face each other on the fixed pieces, respectively, and come into surface contact with both side surfaces of the electrode portion of the cell pouch for a secondary battery by the driving of the electrode actuator, and the electrode module is installed in a mounting groove formed in the pressurization panel, a guide hole extending in a width direction of the cell pouch for a secondary battery is formed in the fixed member, and the fixing position in the width direction is changed by a fixing bolt inserted into a desired position in the guide hole and screw-fastened into the mounting groove.

In the related art, since the reliability of the inspection for the cell pouch for a secondary battery is increased only when the pressurizing force applied to the cell pouch for a secondary battery by each pressurization panel is uniform across the entire pressurized surface, pressurized data for the pressurized surface of the pressurization panel is required, and such a need is not limited to the cell pouch for a secondary battery, but can also apply to all devices that apply a pressurizing force to a pressurization target. Accordingly, the above problem is intended to be solved through the project entitled “Development of an integrated production system equipped with a self-diagnostic KIT for an activation process capable of automatic input and discharge for improving secondary battery productivity” (No. 2410002718), which is a part of the “2024 secondary new support program for secondary battery materials and components technology development” of the Korea Evaluation Institute of Industrial Technology under the Ministry of Trade, Industry and Energy.

The above information disclosed in this Background section is only for understanding of the background of the inventive concepts, and, therefore, it may contain information that does not constitute prior art.

### SUMMARY

Embodiments of the invention are directed to enabling the measurement of the flatness, parallelism, pressurizing force, and even resistance of a pressurization panel that pressurizes a pressurization target and enabling the accurate and easy acquisition and provision of pressurized data for the pressurization panel, thereby enhancing the reliability of various subsequent operations related to a pressurizing process, such as inspection, measurement, monitoring, manufacturing, etc.

Additional features of the inventive concepts will be set forth in the description which follows, and in part will be apparent from the description, or may be learned by practice of the inventive concepts.

According to an aspect of the present invention, there is provided a master cell for pressurized data acquisition, including a cell body inserted between pressurization panels on behalf of a pressurization target, an electronic pressure mapping film which is installed flat on one side surface of the cell body and outputs distribution of a pressurizing force by the pressurization panel as an electrical signal, a communication unit configured to transmit the electrical signal output from the electronic pressure mapping film as a wireless signal, and a battery configured to provide power necessary for the operation of the electronic pressure mapping film and the communication unit.

The battery may be charged by charging power supplied through charging electrodes provided in the cell body.

The battery may further include a housing having a plate-like structure positioned above the electronic pressure mapping film in the cell body, allowing the communication unit and a controller for operation control to be accommodated therein.

The master cell may further include a pair of measuring electrodes provided to protrude from both ends of the cell body, respectively, and used for resistance measurement.

The master cell may further include grip portions provided to be gripped by grippers on both upper sides of the cell body.

According to another aspect of the present invention, there is provided a master cell tray on which a plurality of master cells for pressurized data acquisition according to an aspect of the present invention are mounted in parallel, including a tray body which is open upward, and a plurality of slots provided in parallel inside the tray body such that the master cells for pressurized data acquisition are vertically mounted, respectively.

The slot may be provided between a plurality of supports disposed to be vertically spaced apart from each other on both sides of a bottom surface inside a tray body, allows measuring electrodes, which protrude from both sides of the cell body, to pass through by anti-detachment portions formed on outer sides of each of the supports while blocking passage of the cell body, and by entrance guide portions formed on both upper sides of the anti-detachment portions to be inclined downward, each of the measuring electrodes is guided to be inserted between the anti-detachment portions.

The master cell tray may further include separation supports configured to support both lower sides of the cell body on the bottom surface inside the tray body, thereby forming an accommodation space between the cell body and the bottom surface, and a router which is installed inside the accommodation space and transmits an electrical signal of the electronic pressure mapping film transmitted through communication with the communication unit to an external signal processing device.

The separation support may be provided with an anti-detachment step so as to be caught by a groove formed to allow the charging electrode, which is directed downward for charging the battery, to be positioned inside the lower end of the cell body.

The master cell tray may further include a probe pin provided for each slot to provide charging power by connecting and supporting each of charging electrodes provided at both lower ends of the cell body for charging the battery.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a perspective view illustrating a master cell for pressurized data acquisition and a tray for accommodating the same according to one embodiment of the present invention.

FIG. 2 is a perspective view illustrating the master cell for pressurized data acquisition according to an embodiment of the present invention.

FIG. 3 is a rear perspective view illustrating the master cell for pressurized data acquisition according to an embodiment of the present invention.

FIG. 4 is a configuration diagram illustrating the master cell for pressurized data acquisition according to an embodiment of the present invention.

FIG. 5 is a perspective view of a master cell tray according to an embodiment of the present invention.

FIG. 6 is a front cross-sectional view illustrating the master cell for pressurized data acquisition mounted on the master cell tray according to an embodiment of the present invention.

FIG. 7 is a partial plan view illustrating the master cell for pressurized data acquisition mounted on the master cell tray according to an embodiment of the present invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

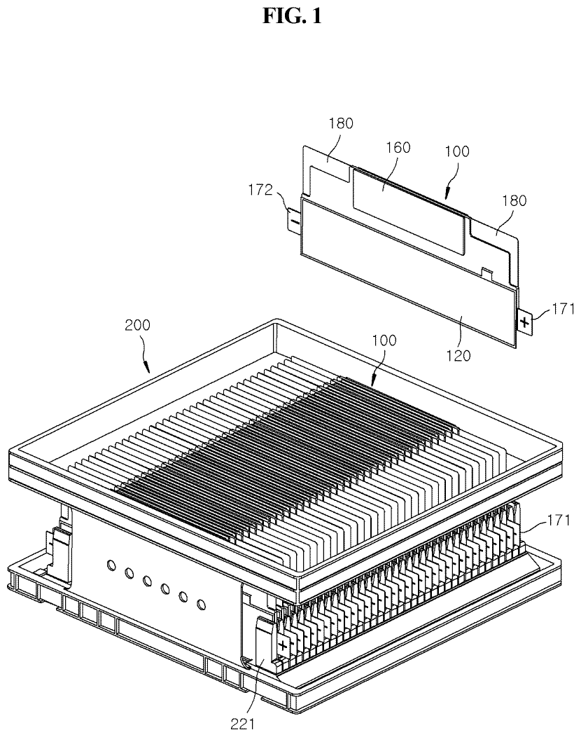

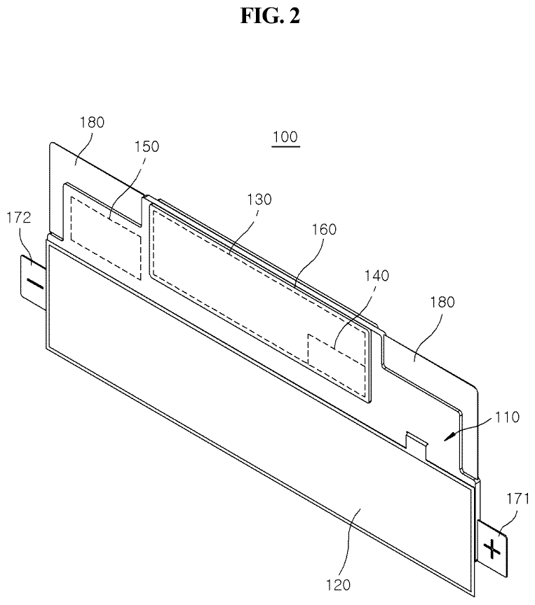

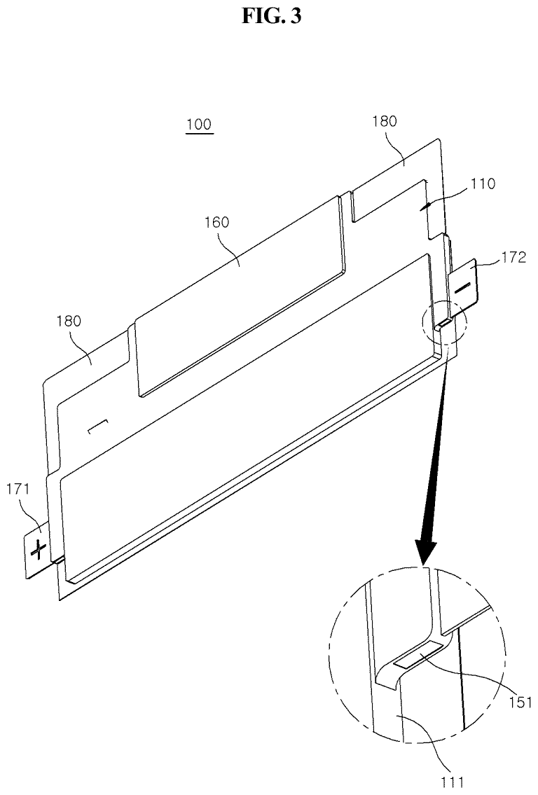

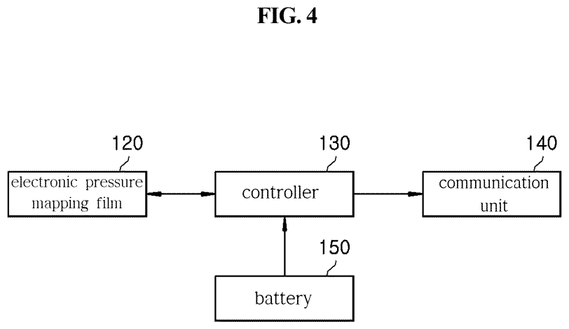

FIG. 1 is a perspective view illustrating a master cell for pressurized data acquisition and a tray for accommodating the same according to one embodiment of the present invention, FIG. 2 is a perspective view illustrating the master cell for pressurized data acquisition according to an embodiment of the present invention, FIG. 3 is a rear perspective view illustrating the master cell for pressurized data acquisition according to an embodiment of the present invention, and FIG. 4 is a configuration diagram illustrating the master cell for pressurized data acquisition according to an embodiment of the present invention.

Referring to FIGS. 1 to 4, a master cell 100 for pressurized data acquisition according to one embodiment of the present invention may include a cell body 110, an electronic pressure mapping film 120, a communication unit 140, and a battery 150.

The cell body 110 is inserted between pressurization panels on behalf of a pressurization target. The pressurization panel may be, for example, a panel for pressurizing a cell pouch for a secondary battery as a pressurization target. However, the pressurization panel is not limited thereto, and may be used for various purposes, such as testing, measurement, manufacturing, etc. In such cases, the pressurization panel may apply pressure to one or both sides of a pressurization target. Accordingly, the cell body 110 may be loaded into a pressurized position on behalf of the pressurization target so as to be pressurized by the pressurization panel.

The electronic pressure mapping film 120 is installed flat on one side surface of the cell body 110 and thus comes into surface contact with the pressurization target, and outputs the distribution of a pressurizing force applied by the pressurization panel as an electrical signal. The electronic pressure mapping film 120 measures pressure applied by multiple pressure sensors two-dimensionally disposed on a flat member, such as a film, a sheet, etc., and outputs an electrical signal that allows a pressure value and pressure distribution to be externally determined. Here, the pressure sensor may be various pressure-sensing elements or pressure-sensing devices that may be implemented in multiple flat members in addition to multiple force sensing resistors (FSR) disposed at regular intervals in X and Y directions on a flat member, such as a film, a sheet, etc.

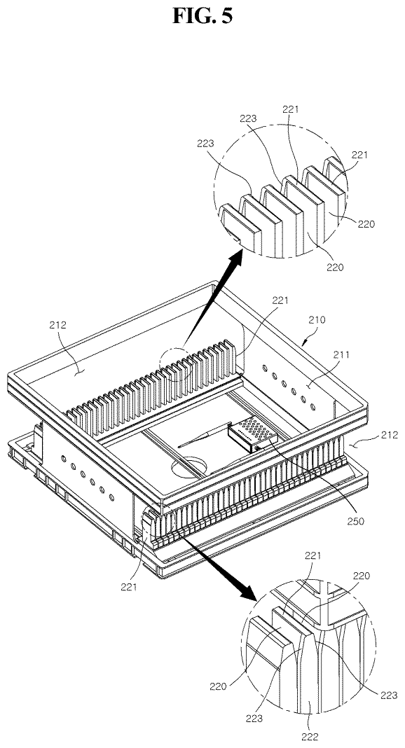

The communication unit 140 may transmit the electrical signal output from the electronic pressure mapping film 120 as a wireless signal. The communication unit 140 may be, for example, a communication device for receiving the electrical signal from the electronic pressure mapping film 120 and transmitting the electrical signal directly to an external signal processing device for processing the electrical signal to output a pressure value and pressure distribution. Alternatively, as another example, the communication unit 140 may be a communication device for transmitting the electrical signal to an external signal processing device via a router 250 (see FIG. 5) by communicating with the router 250 as in the illustrated embodiment. The communication unit 140 may use various communication methods, such as Bluetooth, ultra-wideband (UWB), Zigbee, Wi-Fi, 3G, LTE, 5G, WIBRO, etc., to communicate with the external signal processing device or the router 250.

The communication unit 140 may be, for example, configured to directly convert the electrical signal of the electronic pressure mapping film 120 into the wireless signal and transmit the wireless signal. However, the inventive concepts are not limited thereto. In some embodiments, the communication unit 140 may be configured to receive a transmission signal converted by a controller 130 or the like from the electrical signal of the electronic pressure mapping film 120 and transmit the transmission signal as a wireless signal. According to an embodiment, the communication unit 140 may be configured to be solely responsible for transmitting the electrical signal of the electronic pressure mapping film 120 as the wireless signal, or the communication unit 140 may be configured to be operated by the controller 130 or the like.

The battery 150 provides power necessary for the operation of the electronic pressure mapping film 120 and the communication unit 140, and is charged by charging power supplied through a charging electrode 151 provided at a lower end of the cell body 110 so as to be reused through charging. The controller 130, which will be described below, may be implemented on a printed circuit board (PCB), and such a PCB may also include a charging circuit for charging the battery 150.

The master cell 100 for pressurized data acquisition according to an embodiment of the present invention may further include a housing 160, measuring electrodes 171 and 172, and a grip part 180.

The housing 160 is configured in a plate-like structure so as to be positioned above the electronic pressure mapping film 120 in the cell body 110, thereby allowing the communication unit 140 and the controller 130 for operation control to be accommodated therein while maintaining a compact structure together with the cell body 110. In addition, the housing 160 may be configured such that the battery 150 is accommodated therein as needed. Here, the communication unit 140 may be configured as a separate component from the controller 130 or as a portion of the controller 130. The controller 130 may control the power supply to, and operation of, the electronic pressure mapping film 120 and the communication unit 140 in response to operation signals or control signals received from the outside.

The measuring electrodes 171 and 172 may be provided to protrude from both ends of the cell body 110, respectively, and are used for resistance measurement. The measuring electrodes 171 and 172 may be configured as a pair of a positive measuring electrode 171 and a negative measuring electrode 172, which may have a protruding shape to be connected to an external resistance measurement device and function as resistance measurement probes of such an external resistance measurement device. The measuring electrodes 171 and 172 are connected to resistors with known resistance values and connected to various types of resistance measuring devices to enable calibration based on the known resistance values when measuring resistance.

The grip parts 180 are provided on both upper sides of the cell body 110 to be gripped by grippers (not illustrated), respectively, and may have a flat structure advantageous for gripping. The grip parts 180 may provide a gripping positions when a large number of master cells 100 for pressurized data acquisition are loaded between the pressurization panels by the grippers. To ensure stable gripping, at least two of the grip parts 180 may be provided. In an embodiment, the grip parts 180 may have “L” shape with respect to corners at both sides of the cell body 110.

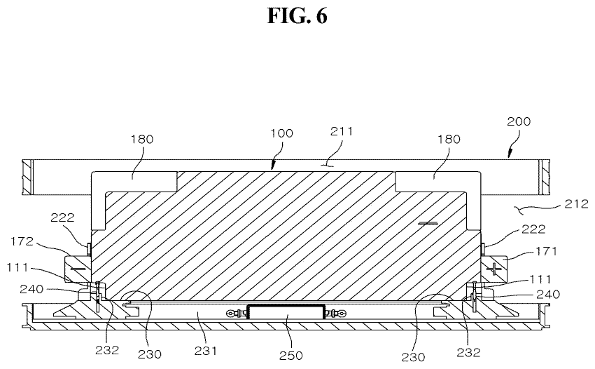

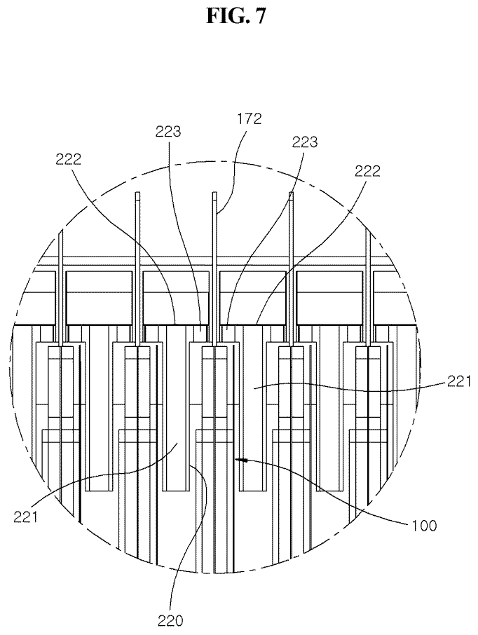

FIG. 5 is a perspective view of a master cell tray according to an embodiment of the present invention, FIG. 6 is a front cross-sectional view illustrating the master cell for pressurized data acquisition mounted on the master cell tray according to an embodiment of the present invention, and FIG. 7 is a partial plan view illustrating the master cell for pressurized data acquisition mounted on the master cell tray according to an embodiment of the present invention.

Referring to FIGS. 5 to 7, a master cell tray 200 according to one embodiment of the present invention may be a tray, in which a plurality of master cells 100 for pressurized data acquisition according to an embodiment of the present invention are mounted in parallel, and may include a tray body 210 and a slot 220.

The tray body 210 may be open upward, and to this end, an upper opening 211 may be formed at the top to allow the master cell 100 for pressurized data acquisition to be inserted and removed through the top. In addition, the tray body 210 may be open laterally such that side openings 212 may be formed at both sides to check the master cell 100 for pressurized data acquisition accommodated therein.

A plurality of slots 220 may be provided in parallel such that the master cell 100 for pressurized data acquisition is vertically mounted on an inner side of the tray body 210.

The slot 220 may be provided between a plurality of supports 221 that are vertically spaced apart from each other on both sides of a bottom surface inside the tray body 210. Anti-detachment portions 222 may be provided on an outer side of each support 221 to allow the penetration of the measuring electrodes 171 and 172 protruding from both sides of the cell body 110 while blocking the passage of the cell body 110. The measuring electrodes 171, 172 may be guided to be inserted between the anti-detachment portions 222 by entrance guide portions 223 provided on both upper sides of the anti-detachment portions 222 to be inclined downward. As illustrated in FIG. 7, the anti-detachment portion 222 has a “T” shaped flat structure together with the support 221, as the structure intersects the end of the support 221. This configuration can block the passage of the cell body 110 while allowing the penetration of the measuring electrodes 171 and 172. Accordingly, when the master cell 100 for pressurized data acquisition is positioned inside the slot 220 formed between the supports 221, only the measuring electrodes 171 and 172 may be formed to pass through a narrowed gap between the anti-detachment portions 222.

According to one embodiment of the present invention, the master cell tray 200 may further include a separation support 230 for supporting the upper separation of the cell body 110, the router 250 for providing the electrical signal of the electronic pressure mapping film 120 in the master cell 100 for pressurized data acquisition to the external signal processing device through communication, and a probe pin 240 for providing charging power to the battery 150 of the master cell 100 for pressurized data acquisition accommodated therein.

The separation support 230 may support both lower sides of the cell body 110 on the bottom surface within the tray body 210, thereby forming an accommodation space 231 between the cell body 110 and the bottom surface inside the tray body 210. The separation support 230 may be provided with an anti-detachment step 232 so as to be caught by a groove 111 formed to allow the charging electrode 151, which is directed downward for charging the battery 150, to be positioned inside the lower end of the cell body 110. Accordingly, the separation support 230 may support both lower sides of the cell body 110 to be spaced apart from the bottom surface of the tray body 210, thereby forming the accommodation space 231 for accommodating the router 250, and by the anti-detachment step 232 that may be caught on the grooves 111 formed in both lower sides of the cell body 110 enables the probe pin 240 to remain laterally connected to the charging electrode 151 of the cell body 110 without being detached.

The router 250 may be installed inside the accommodation space 231 and may provide the electrical signals of the electronic pressure mapping film 120 to the external signal processing device in a wireless communication manner through the communication with the communication unit 140. To this end, the router 250 may use various communication methods, such as Wi-Fi, 3G, LTE, 5G, WIBRO, etc., to mediate the communication between the communication unit 140 and the external signal processing device. The external signal processing device may process the electrical signal of the electronic pressure mapping film 120 according to a predetermined process and output the pressure force, flatness, parallelism, etc. of the pressurization panel through the electronic pressure mapping film 120 to a display device or a predetermined terminal.

The probe pins 240 may be provided in each slot 220 such that each charging electrode 151, which is provided on both lower sides of the cell body 110 for charging the battery 150, is supported in a connected state to receive charging power. Accordingly, the probe pins 240 may be disposed in two rows in the arrangement direction of the cell bodies 110 on the bottom surface of the tray body 210, thereby allowing the charging power to be supplied to the charging electrodes 151 respectively positioned on both lower sides of each cell body 110. The probe pins 240 may have a structure capable of vertical expansion and contraction within a limited range and may be elastically restored upward by an internal spring, thereby allowing stable contact with the charging electrodes 151 to be maintained and minimizing an impact applied to the charging electrodes 151. In addition, the probe pins 240 may distribute and supply the converted charging power to the charging electrodes 151, the charging power being supplied through a power cable pulled out from the tray body 210.

According to the master cell for pressurized data acquisition and the tray for accommodating the same, it is possible to enable the measurement of the flatness, parallelism, pressurizing force, and even resistance of a pressurization panel that pressurizes a pressurization target and enables the accurate and easy acquisition and provision of pressurized data for the pressurization panel.

In addition, according to embodiments of the present invention, the above operations make it possible to enhance the reliability of various subsequent operations related to the pressurization process, such as inspection, measurement, monitoring, manufacturing, etc.

According to the master cell for pressurized data acquisition and the tray for accommodating the same according to embodiments of the invention, it is possible to enable the measurement of the flatness, parallelism, pressurizing force, and even resistance of a pressurization panel that pressurizes a pressurization target and enable the accurate and easy acquisition and provision of pressurized data for the pressurization panel, thereby enhancing the reliability of various subsequent operations related to a pressurizing process, such as inspection, measurement, monitoring, manufacturing, etc.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A master cell for pressurized data acquisition, comprising:
a cell body inserted between pressurization panels on behalf of a pressurization target;
a pair of measuring electrodes to measure resistance, which protrude from both ends of the cell body, respectively, and are connected to resistors with known resistance values for calibration;
an electronic pressure mapping film installed flat on one side surface of the cell body to come into surface contact with the pressurization target and configured to output distribution of a pressurizing force by the pressurization panel as an electrical signal;
a communication unit configured to transmit the electrical signal output from the electronic pressure mapping film as a wireless signal; and
a battery provided in the cell body and configured to provide power necessary for the operation of the electronic pressure mapping film and the communication unit,
wherein the battery is charged by charging power supplied through charging electrodes provided in the cell body.

2. The master cell of claim 1, further comprising a housing having a plate-like structure positioned above the electronic pressure mapping film in the cell body, allowing the communication unit and a controller for operation control to be accommodated therein.

3. The master cell of claim 1, further comprising grip portions provided to be gripped by grippers on both upper sides of the cell body.

4. A master cell tray on which a plurality of master cells for pressurized data acquisition according to claim 1 are mounted in parallel, the master cell tray comprising:
a tray body which is open upward; and
a plurality of slots provided in parallel inside the tray body such that the master cells for pressurized data acquisition are vertically mounted, respectively.

5. A master cell tray on which a plurality of master cells for pressurized data acquisition according to claim 2 are mounted in parallel, the master cell tray comprising:
a tray body which is open upward; and
a plurality of slots provided in parallel inside the tray body such that the master cells for pressurized data acquisition are vertically mounted, respectively.

6. A master cell tray on which a plurality of master cells for pressurized data acquisition according to claim 3 are mounted in parallel, the master cell tray comprising:
a tray body which is open upward; and
a plurality of slots provided in parallel inside the tray body such that the master cells for pressurized data acquisition are vertically mounted, respectively.

7. The master cell tray of claim 4, wherein the slot is provided between a plurality of supports disposed to be vertically spaced apart from each other on both sides of a bottom surface inside the tray body, allows measuring electrodes, which protrude from both sides of the cell body, to pass through by anti-detachment portions formed on outer sides of each of the supports while blocking passage of the cell body, and by entrance guide portions formed on both upper sides of the anti-detachment portions to be inclined downward, each of the measuring electrodes is guided to be inserted between the anti-detachment portions.

8. The master cell tray of claim 5, wherein the slot is provided between a plurality of supports disposed to be vertically spaced apart from each other on both sides of a bottom surface inside the tray body, allows measuring electrodes, which protrude from both sides of the cell body, to pass through by anti-detachment portions formed on outer sides of each of the supports while blocking passage of the cell body, and by entrance guide portions formed on both upper sides of the anti-detachment portions to be inclined downward, each of the measuring electrodes is guided to be inserted between the anti-detachment portions.

9. The master cell tray of claim 6, wherein the slot is provided between a plurality of supports disposed to be vertically spaced apart from each other on both sides of a bottom surface inside the tray body, allows measuring electrodes, which protrude from both sides of the cell body, to pass through by anti-detachment portions formed on outer sides of each of the supports while blocking passage of the cell body, and by entrance guide portions formed on both upper sides of the anti-detachment portions to be inclined downward, each of the measuring electrodes is guided to be inserted between the anti-detachment portions.

10. The master cell tray of claim 4, further comprising:
separation supports configured to support both lower sides of the cell body on the bottom surface inside the tray body, thereby forming an accommodation space between the cell body and the bottom surface; and
a router which is installed inside the accommodation space and transmits an electrical signal of the electronic pressure mapping film transmitted through communication with the communication unit to an external signal processing device.

11. The master cell tray of claim 5, further comprising:
separation supports configured to support both lower sides of the cell body on the bottom surface inside the tray body, thereby forming an accommodation space between the cell body and the bottom surface; and
a router which is installed inside the accommodation space and transmits an electrical signal of the electronic pressure mapping film transmitted through communication with the communication unit to an external signal processing device.

12. The master cell tray of claim 6, further comprising:
separation supports configured to support both lower sides of the cell body on the bottom surface inside the tray body, thereby forming an accommodation space between the cell body and the bottom surface; and
a router which is installed inside the accommodation space and transmits an electrical signal of the electronic pressure mapping film transmitted through communication with the communication unit to an external signal processing device.

13. The master cell tray of claim 10, wherein the separation support is provided with an anti-detachment step so as to be caught by a groove formed to allow the charging electrode, which is directed downward for charging the battery, to be positioned inside the lower end of the cell body.

14. The master cell tray of claim 11, wherein the separation support is provided with an anti-detachment step so as to be caught by a groove formed to allow the charging electrode, which is directed downward for charging the battery, to be positioned inside the lower end of the cell body.

15. The master cell tray of claim 12, wherein the separation support is provided with an anti-detachment step so as to be caught by a groove formed to allow the charging electrode, which is directed downward for charging the battery, to be positioned inside the lower end of the cell body.

16. The master cell tray of claim 4, further comprising a probe pin provided for each slot to provide charging power by connecting and supporting each of charging electrodes provided at both lower ends of the cell body for charging the battery.

17. The master cell tray of claim 5, further comprising a probe pin provided for each slot to provide charging power by connecting and supporting each of charging electrodes provided at both lower ends of the cell body for charging the battery.

18. The master cell tray of claim 6, further comprising a probe pin provided for each slot to provide charging power by connecting and supporting each of charging electrodes provided at both lower ends of the cell body for charging the battery.
